(19) United States
(12) Patent Application Publication
(10) Pub. No.: US 2026/0369568 A1
(43) Pub. Date: Nov. 19, 2026

(54) ELECTRONICALLY CONDUCTIVE OXIDE COATED ALL ACTIVE MATERIAL SINTERED ELECTRODE

(71) Applicant: University of Virginia Patent Foundation, Charlottesville, VA (US)

(72) Inventors: Gary M. Koenig, JR., Fishersville, VA (US); Chen Cai, Charlottesville, VA (US)

(21) Appl. No.: 19/478,129

(22) PCT Filed: Apr. 24, 2024
(86) PCT No.: PCT/US2024/026001

§ 371 Date: Oct. 23, 2025

Related U.S. Application Data
(60) Provisional application No. 63/497,879, filed on Apr. 24, 2023.

(51) Int. Cl. H01M 4/36; H01M 4/04; H01M 4/525; H01M 10/0525

(52) U.S. Cl. CPC H01M 4/366; H01M 4/0471; H01M 4/525; H01M 10/0525

(57) ABSTRACT

A device may include an electrochemical storage device comprising a two electroactive materials, where one of the materials is in much lower weight fraction and functions to facilitate electronic conductions through the electrode matrix. One system includes layered oxide LiNi0.80Co0.15Al0.05O2 (NCA) at least partially coated with a coating with stoichiometry LixCoyOz (LCO).

### CLAIM OF PRIORITY AND CROSS-REFERENCE TO RELATED APPLICATIONS

This application claims the benefit of priority to U.S. Provisional Patent Application Ser. No. 63/497,879 entitled “ELECTRONICALLY CONDUCTIVE OXIDE COATED ALL ACTIVE MATERIAL SINTERED ELECTRODE,” filed Apr. 24, 2023, which is incorporated herein in its entirety by reference.

### STATEMENT OF GOVERNMENT SUPPORT

This invention was made with Government support under 1652488 awarded by the National Science Foundation. The U.S. Government has certain rights in this invention.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various aspects of the present subject matter.

FIG. 1 is a schematic figure showing a process for making all active material (AAM) electrode of NCA particles coated with LCO material.

FIG. 2 shows XRD patterns of the surfaces of sintered AAM electrode pellets after thermal treatment of Blend, pure NCA, and pure LCO electrodes. The cutout on the right is an expansion of the (003) peak region for LCO and NCA. Peak assignments were based on ICSD 259670 for NCA and ICSD 51381 for LCO.

FIG. 3 is a graph showing first cycle charge/discharge profiles for NCA and LCO processed into composite cathodes and paired with lithium metal anodes. The rate for both charge and discharge was C/20, which corresponded to 106.8 μA cm−2 and 15.8 μA cm−2 for the NCA and LCO cells, respectively. C rate was assigned based on the cathode active material loading in the cells and assuming a capacity of 200 mAh g−1 NCA and 137 mAh g−1 LCOFIG.

FIG. 4A, FIG. 4B, and FIG. 4C comprise a series of graphs showing, in FIG. 4A, First cycle charge/discharge voltage profiles at C/50 (0.6 mA cm−2) , in FIG. 4B, dQ/dV of first charge cycle (from a), and in FIG. 4C, rate capability test for 0% LCO, 2.5% LCO, 5% LCO, and 10% LCO. The different C rates for the rate capability evaluation are indicated on the plot, and charge and discharge were at the same C rate. Voltage window for all cycles was 1.0 V to 2.8 V (cell).

FIG. 5 is a graph showing discharge voltage profile of the AAM NCA cathode at 0.1 mA after the rate capability test in FIG. 2a. Anode was AAM LTO.

FIG. 6A, FIG. 6B, FIG. 6C, FIG. 6D, FIG. 6E, FIG. 6F, and FIG. 6G comprise a series of Nyquist plots extracted from EIS conducted on the thinner AAM electrodes of 0% LCO and 5% LCO. In FIG. A, EIS was performed on cells after initial preparation and in FIGS. 6B-6G at 0.1 V increments between (b)-(g) 3.8-4.3 V (vs. Li/Li⁺). Charging occurred at 0.5 mA cm⁻², or ~C/20. The combined counter and reference electrode was lithium metal foil.

FIG. 7A and FIG. 7B comprise a series of graphs showing in FIG. 7A volumetric capacity comparison on a cathode total electrode volume basis for cells with the AAM cathodes of 0% LCO, 2.5% for 0% LCO, 2.5% LCO, 5% LCO, and 10% LCO. C/50 corresponded to 0.6 mA cm⁻² and in FIG. 7B, Ragone plot for AAM cathodes in this and prior work, where the cathode mass loadings were similar and all anodes were nominally identical AAM LTO.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

Lithium-ion batteries (LIB) for decades have propelled products that impact our lives. Extensive research has been devoted to pursuing further increasing energy density. One generally applicable route to achieve higher energy density is to increase the electrode thickness, which reduces the relative volume fractions of inactive but necessary components, such as current collectors, at the cell level. However, the use of conventional composite electrodes from slurry casting processes have inherent mechanical limitations when made thick. In addition, limitations to ionic transport through the electrode microstructure are exacerbated by the presence of conductive additives and polymer binders in the electroactive material interstitial regions.

To further optimize the manufacturing process of the AAM electrodes, a controlled atmosphere sintering environment may be employed. This environment can be tailored to include inert gases, such as argon or nitrogen, to prevent unwanted reactions with atmospheric oxygen that could lead to the formation of impurities or affect the stoichiometry of the coated NCA particles. Additionally, the sintering process can be modified to include a multi-step temperature ramp with hold times at specific temperatures to ensure uniform coating and crystallinity of the LCO material on the NCA substrate. This controlled sintering process aims to enhance the mechanical integrity and electrical connectivity of the sintered electrode, thereby improving its electrochemical performance.

To overcome such drawbacks, all active material (AAM) electrodes fabricated from compressing and mildly sintering of electroactive material powder (referred to in some prior work as “sintered electrodes”) has emerged recently, with areal loadings over 100 mg cm⁻² and thicknesses in some cases exceeding 1 mm. In the absence of conductive additives such as carbon black, electronic conduction through the electrode matrix must be facilitated by the electroactive material itself in AAM electrodes. Many prior AAM electrode reports have used Li₄Ti₅O₁₂ (LTO) anodes and LiCoO₂ (LCO) cathodes, where electrode matrix electronic overpotential was not expected to limit electrochemical properties due to the electronic conductivity of these materials being >10 Sm⁻¹ across the range of lithiation expected during charge/discharge. However, for other electroactive materials limitations in rate capability for AAM electrode cells were attributed to limited electronic conductivity. An example was when the relatively low cost, and low electronic conductivity, LiMn₂O₄ (LMO) was evaluated as an AAM electrode.

Alternative layered phase metal oxide cathodes, such as LiNi_{0.80}Co_{0.15}Al_{0.05}O₂ (NCA) and LiNi_{0.5}Mn_{0.5}O₂ (LNMO), would be desirable to substitute for LCO in AAM electrodes due to higher energy density and lower cost from reduced cobalt. However, NCA or LNMO have much lower electronic conductivity than LCO, which suggested processing strategies would be needed to mitigate this limitation. In a previous report, LCO and LNMO particles were physically blended before being processed into AAM cathodes. Analysis of these electrodes suggested that the LNMO and LCO phases remained segregated, and that above a threshold of LCO content the percolated LCO network facilitated increased electronic conductivity through the electrode matrix resulting in improved retention of electrochemical capacity at increasing rates of charge/discharge. However, the relatively high amount of the lower energy density LCO material necessary to improve electrode electronic conductivity limited the energy density improvements that may be accessed by use of higher energy density LNMO.

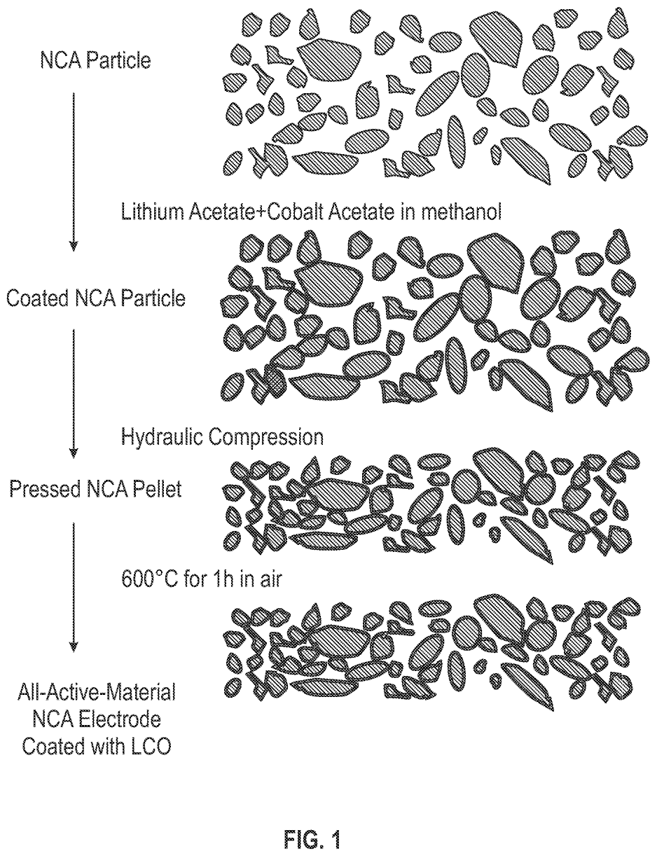

Herein, a single-step process (FIG. 1) is disclosed to produce a material powder with NCA particles coated by a second material targeted to the composition of LCO. Via this electrode processing strategy, the concept includes a LCO network throughout the electrode thickness for carrying electronic current while using much lower relative amounts of LCO material compared to the previous percolated network strategy (as will be shown later, around 5 wt % compared to 45 wt %). Thus, increased energy density cells are possible with much higher relative amounts of the high energy density NCA material. This study describes a strategy to enable high energy density AAM electrodes using materials that otherwise would not be suitable due to electronic conductivity limitations.

According to an aspect of this disclosure, LCO was synthesized via sol-gel method. As further disclosed, LCO can be processed into both composite and sintered electrodes and evaluated electrochemically when paired in half and full cell configurations. The outcomes disclosed herein show that LCO is a suitable material as a sintered anode, providing stable and reversible electrochemical cycling.

The improved AAM electrodes described herein are particularly suitable for high-energy-density applications where weight and volume are critical factors. These applications include, but are not limited to, electric vehicles, aerospace energy storage systems, portable electronic devices, and stationary energy storage systems for grid support. The enhanced rate capability and energy density of the coated NCA electrodes make them an attractive option for these sectors, potentially leading to longer operational ranges for electric vehicles, extended mission durations for aerospace applications, longer battery life for consumer electronics, and more efficient energy storage solutions for renewable energy integration.

More specifically, the instant disclosure shows that the energy density of lithium-ion batteries at a cell level can be improved via increasing thickness and reducing inactive material content of electrodes. One system which achieves both attributes are sintered electrodes comprised of porous thin films of only electroactive material. Li₄Ti₅O₁₂ has often been the used as a sintered anode, however, higher energy density anodes could significantly improve cell energy density. As disclosed herein, LCO was synthesized and evaluated as a sintered anode material with an NCA coating. Sintered LCO had stable cycling and relatively high volumetric energy density, suggesting LCO has promise as a sintered anode.

Sintered electrodes have been reported which are free of inactive conductive additives and binders, with high loadings exceeding 150 mg cm⁻² and thicknesses over 500 μm. The electrode microstructure for sintered electrodes does not contain inactive additives in the interstitial regions between particles, and thus sintered electrodes have lower tortuosity than conventional composite electrodes. However, the electrodes are still very thick, and thus ion transport limitations through the microstructure and electron transport through the electrode matrix can result in high polarization and rate capability limitations. Because electron conduction through the electrode matrix must proceed through the electroactive material itself in sintered electrodes, materials with relatively high electronic conductivity across the range of extents of lithiation experienced during charge/discharge of the cell are desirable.

According to various examples of the instant disclosure, sintered cathodes containing LCO coated at least in part by NCA, will be described. In view of the foregoing, in accordance with various aspects, an electrochemical storage device can include an electrode. The electrode can include many suitable materials. Examples of suitable materials can include LCO coated at least in part by NCA. Depending on various aspects, the electrode can be an anode or a cathode. In some examples, the cathode or anode can include at least one dopant, at least two dopants, or any suitable number. The at least one dopant has a 1⁺, 2⁺, or 3⁺ oxidation state. As non-limiting examples, the at least one dopant comprises copper, aluminum, sulfur, potassium, or a mixture thereof.

The electrochemical storage device comprising the layered oxide LiNi0.80Co0.15Al0.05O2 (NCA) coated with LixCoyOz (LCO) presents several advantages over existing battery technologies. The unique coating process not only improves the electronic conductivity of the NCA material but also enhances the structural stability of the electrode during charge-discharge cycles. This stability mitigates common degradation mechanisms such as particle cracking and electrolyte decomposition, which are prevalent in uncoated NCA electrodes. As a result, the coated NCA electrodes exhibit improved cycle life and capacity retention, which are critical for the longevity and reliability of lithium-ion batteries. Furthermore, the ability to tailor the thickness and porosity of the electrodes provides additional avenues to optimize the battery for specific applications, allowing for a balance between energy density and power delivery.

The optimal composition ranges for the LCO coating on the NCA particles have been determined through extensive electrochemical testing and characterization. The data suggests that a coating amount in the range of approximately 2.5 wt % to 5 wt % LCO relative to NCA provides a significant improvement in electronic conductivity and rate capability without compromising the volumetric energy density of the electrode. Coatings below 2.5 wt % may not form a continuous conductive network, leading to suboptimal rate performance, while coatings above 5 wt % may introduce excessive porosity and reduce the overall energy density. The disclosed embodiments with 2.5 wt % and 5 wt % LCO coatings have demonstrated an optimal balance, achieving high capacity retention across a range of current densities while maintaining structural integrity and energy density. This balance is critical for the practical application of AAM electrodes in high-performance lithium-ion batteries.

In the pursuit of achieving the highest electrochemical performance, the thickness of the LCO coating layer on the NCA particles is a critical parameter. Based on the experimental data, an optimal thickness range has been identified that ensures sufficient electronic conductivity while maintaining the structural and electrochemical integrity of the electrode. The coating thickness is ideally maintained within a range that allows for the creation of a continuous conductive pathway across the NCA particles without leading to excessive insulation or hindrance of lithium-ion diffusion. The experimental results suggest that a coating thickness corresponding to the 2.5 wt % to 5 wt % LCO range, as previously discussed, provides the optimal balance. This thickness range ensures that the LCO forms a coherent and conductive layer on the NCA particles, enhancing the rate capability and reducing the charge transfer resistance, which is essential for high-rate applications. The precise control of the coating thickness within this range is achieved through the careful calibration of the precursor solution concentrations and the sintering process parameters.

The benefits of the electrodes described herein can be achieved when the electrode is a sintered electrode or a composite electrode. In examples where the electrode is a composite. While not so limited, a substrate can include a stainless steel, aluminum, alloys thereof, or mixtures thereof.

As explained herein, electrode thickness is an important parameter of the electrode. As an example, a thickness of the electrode can be in a range of from about 50 μm to about 2000 μm, about 70 μm to about 400 μm, less than, equal to, or greater than about 50 μm, 60, 70, 80, 90, 100, 110, 120,130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1110, 1120, 1130, 1140, 1150, 1160, 1170, 1180, 1190, 1200, 1210, 1220, 1230, 1240, 1250, 1260, 1270, 1280, 1290, 1300, 1310, 1320, 1330, 1340, 1350, 1360, 1370, 1380, 1390, 1400, 1410, 1420, 1430, 1440, 1450, 1460, 1470, 1480, 1490, 1500, 1510, 1520, 1530, 1540, 1550, 1560, 1570, 1580, 1590, 1600, 1610, 1620, 1630, 1640, 1650, 1660, 1670, 1680, 1690, 1700, 1710, 1720, 1730, 1740, 1750, 1760, 1770, 1780, 1790, 1800, 1810, 1820, 1830, 1840, 1850, 1860, 1870, 1880, 1890, 1900, 1910, 1920, 1930, 1940, 1950, 1960, 1970, 1980, 1990, or about 2000 μm.

A porosity of the electrode can be in a range of from about 30% to about 50%, about 35% to about 40%, less than, equal to, or greater than about 30%, 31, 32, 33, 34, 35, 36, 37, 38, 39, 40, 41, 42, 43, 44, 45, 46, 47, 48, 49, or about 50%. The porosity can alternatively be expressed as a void space of the portion of the electrode that is empty. The pores can be through pores in some examples.

According to various examples, the electrode is substantially free of any conductive additives. For example, the electrode can include about 0 wt % to about 5 wt % conductive additive, about 0 wt % to about 0.50 wt %, less than, equal to, or greater than about 0 wt %, 0.1, 0.2, 0.3. 0.4, . 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or about 5 wt %. Non limiting examples of conductive additives that the electrode is free of include a polymer binder, a conductive carbon, or a mixture thereof.

The material(s) and construction of the electrode can control the capacity of the electrode. As an example, the capacity of the electrode can be in a range of from about 7 mAh/cm² to about 200 mAh/cm², about 10 mAh/cm² to about 50 mAh/cm², less than, equal to, or greater than about 7 mAh/cm², 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107. 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199 or about 200 mAh/cm².

The electrode, in some aspects, can be associated with an electrically conductive current collector to facilitate the flow of electrons between the electrode and an exterior circuit. The current collector can include metal, such as a metal foil or a metal grid. In some aspects, the current collector can be formed from nickel, aluminum, stainless steel, copper or the like. The electrode material can be cast as a thin film onto the current collector. The electrode material with the current collector can then be dried, for example in an oven, to remove solvent from the sintered electrode. In some aspects, the dried sintered electrode material in contact with the current collector foil or other structure can be subjected to a pressure, such as, from about 2 to about 10 kg/cm² (kilograms per square centimeter).

The separator is located between the positive electrode and the negative electrode. The separator is electrically insulating while providing for at least selected ion conduction between the two electrodes. A variety of materials can be used as separators. Commercial separator materials are generally formed from polymers, such as polyethylene and/or polypropylene that are porous sheets that provide for ionic conduction. Commercial polymer separators include, for example, the Celgard® line of separator material from Hoechst Celanese, Charlotte, N.C. Also, ceramic-polymer composite materials have been developed for separator applications. These composite separators can be stable at higher temperatures, and the composite materials can significantly reduce the fire risk. In some further examples the separator can include glass fibers. Glass fiber separators can be especially useful when a sintered electrode is used.

The electrolyte includes solvated ions as electrolytes, and ionic compositions that dissolve to form solvated ions in appropriate liquids are referred to as electrolyte salts. Electrolytes for lithium ion batteries can comprise one or more selected lithium salts. Appropriate lithium salts generally have inert anions. Suitable lithium salts include, for example, lithium hexafluorophosphate, lithium hexafluoroarsenate, lithium bis(trifluorometh yl sulfonyl imide), lithium trifluoromethane sulfonate, lithium tris(trifluoromethyl sulfonyl) methide, lithium tetrafluoroborate, lithium perchlorate, lithium tetrachloroaluminate, lithium chloride, lithium difluoro oxalato borate, and combinations thereof. Traditionally, the electrolyte comprises a 1 M concentration of the lithium salts, although greater or lesser concentrations can be used.

A non-aqueous liquid can be used to dissolve the lithium salt(s). The solvent generally does not dissolve the electroactive materials. Appropriate solvents include, for example, propylene carbonate, dimethyl carbonate, diethyl carbonate, 2-methyl tetrahydrofuran, dioxolane, tetrahydrofuran, methyl ethyl carbonate, y-butyrolactone, dimethyl sulfoxide, acetonitrile, formamide, dimethyl formamide, triglyme (tri(ethylene glycol) dimethyl ether), diglyme (diethylene glycol dimethyl ether), DME (glyme or 1,2-dimethyloxyethane or ethylene glycol dimethyl ether), nitromethane and mixtures thereof.

The electrodes described herein can be incorporated into various commercial battery designs, such as prismatic shaped batteries, wound cylindrical batteries, coin batteries or other reasonable battery shapes. The batteries can comprise a single sintered electrode stack or a plurality of sintered electrodes of each charge assembled in parallel and/or series electrical connection(s). Appropriate electrically conductive tabs can be welded or the like to the current collectors, and the resulting jellyroll or stack structure can be placed into a metal canister or polymer package, with the negative tab and positive tab welded to appropriate external contacts. Electrolyte is added to the canister, and the canister is sealed to complete the battery. Some presently used rechargeable commercial batteries include, for example, the cylindrical 18650 batteries (18 mm in diameter and 65 mm long) and 26700 batteries (26 mm in diameter and 70 mm long), although other battery sizes can be used.

The sintered electrode can be formed according to many suitable methods. For example, the electroactive material of the electrode is sintered. Sintering can be performed at a temperature in range of from about 500 °C to about 1100 °C, about 700 °C to about 900 °C, less than, equal to, or greater than about 500 °C, 550, 600, 650, 700, 750, 800, 850, 900, 950, 1000, 1050, or about 1100 °C. Sintering can be conducted at a constant temperature or at a variable temperature during the sintering process. Sintering can last for any amount of time in a range of from about 0 hours to about 20 hours, about 12 hours to about 18 hours, less than, equal to, or greater than about 0 hours, 1, 2, 3, 4, 5, 6, 7, 8, 9, 10, 11, 12, 13, 14, 15, 16, 17, 18, 19, or about 20 hours. Sintering can be conducted in one step or across multiple sintering steps.

Alternatively, a composite electrode can be formed by disposing the electroactive material on a substrate. The electroactive material can be in the form of a slurry mixed with a solvent, carbon source, and any other suitable component. The substrate can be an aluminum foil. After the slurry is disposed on the substrate, the slurry is allowed to dry in an oven to form the electrode.

As mentioned previously, in some aspects the electrode can include a degree of porosity. The structure and/or arrangement of pores in the sintered electrode microstructure can lead to additional improvements in the energy and power density of the energy storage device to which the electrode is incorporated. As an example, aligning the pores can improve these properties. One method that can be used to accomplish this is to fabricate an electrode using reactants that are capable of forming an anisotropic structure. This can be accomplished by producing an anisotropic precipitate particle that includes a single transition metal or multiple transition metals. The precipitate can be used as a precursor template in formulating battery active material having an anisotropic morphology. Any suitable transition metal can be used to form the precursor template.

In producing the sintered electrode, there are different strategies to improve or overcome inherent electronic conductivity limitations of electroactive materials. One route is to dope the electroactive material with elements that result in increased electronic conductivity. There are limits to the electronic conductivity improvements via doping methods and at too high of a doping level secondary phases can result. Another option is to carbon coat the electroactive material, and this strategy has been attributed to improving rate capability of other low electronic conductivity electroactive materials such as LiFePO₄. Carbon coating of electroactive materials has been broadly reported for improved interfacial stability and electronic conductivity. Sucrose is a common carbon source that also can serve as a particulate binder material. As described herein a carbon coated sintered electrode can be produced using sucrose both as a sacrificial binder for sintered electrode processing and as a carbon source, where the carbon coating process does not require an extra step for treating the electroactive material powder or the sintered porous pellet relative to processing the electrodes without the coating.

The electrochemical storage device described herein can be disposed in many suitable articles. For example, the electrochemical storage device can be disposed in vehicle (e.g., an electric vehicle) or an electronic device.

### Examples

Various aspects of the present subject matter can be better understood by reference to the following Examples which are offered by way of illustration. The present subject matter is not limited to the Examples given herein.

### Methods and Materials

### Electrode Fabrications

Composite electrodes: The NCA material processed into composite electrodes was received from Cell Analysis, Modeling, and Prototyping Facility (CAMP) at Argonne National Lab. The NCA material supplier was Toda (Lot #4090603), and the areal loading was 10 mg cm⁻². Cathodes were directly punched from received composite foils into a circular shape with diameter of 1.3 cm. These cathodes were then paired with lithium metal anodes and fabricated into coin cells, where the anode was also directly punched out into circular shape from a lithium foil with an area of 1.6cm².

AAM electrodes: For cells using AAM electrodes, the NCA electroactive material powder was also used as received from CAMP facilities, and the NCA powder was the same material that had been processed into the composite electrodes received from CAMP. The AAM electrodes were prepared as follows: for pure NCA electrodes (“0% LCO”), NCA powder was first coated with polyvinyl butyral (PVB, Pfaltz & Bauer) by blending 1.0 g of NCA powder with 2.0 mL of 1.0 wt % PVB dissolved in ethanol using a mortar and pestle by hand until dry. The dried powder coated with PVB was then loaded into a circular pellet die with diameter of 1.3 cm (Carver) and hydraulically pressed at 400 MPa for 2 mins. The porous pellet was then heated to a target hold temperature of 600 °C for 1 hour, with both ramp up and down rates of 1 °C min⁻¹.

NCA coated with 2.5 wt %, 5.0 wt %, and 10.0 wt % LCO were referred to as “2.5% LCO”, “5% LCO”, and “10% LCO”, respectively. However, as will be described in the later sections the coating was likely not pure LCO (i.e., high crystallinity LiCoO₂), and such abbreviation was used to match the target compound and for convenience of comparison. A methanol solution containing cobalt acetate and lithium acetate was first prepared. 10 mL of methanol was poured into the pestle before adding 0.127 g of cobalt acetate dihydrate (Sigma-Aldrich) and 0.052 g of lithium acetate dihydrate (Sigma-Aldrich). The solution was stirred using a pestle until dissolved before adding NCA powder and blending until fully dried. The ratio between NCA powder and methanol solution were 0.975 g of NCA with 5.0 mL of solution, 0.95 g of NCA with 10.0 mL of solution, and 0.45 g of NCA with 10.0 mL solution for 2.5% LCO, 5% LCO, and 10% LCO, respectively. The NCA/metal acetate blend then followed the identical compression and heating steps as the 0% LCO material. The resulting pellets had loadings ranging from 136-144 mg cm⁻², thicknesses of 420-590 μm, and geometric pore/void fractions which will be detailed later. The AAM anode used LTO (NEI corporation), and had the same compression and heating procedures as described for the 0% LCO. The resulting LTO pellets had loadings of 190-195 mg cm⁻², geometric pore/void fractions of ~0.41, and thicknesses ranging from 910-950 μm. For the 0% LCO and 5% LCO AAM cathodes, thinner electrodes with loadings between 54-66 mg cm⁻² and thicknesses between 170-210 μm were fabricated for direct current (DC) electronic conductivity measurements. In addition, 0% LCO and 5% LCO AAM cathodes with loading between 34-39 mg cm⁻² and thickness between 100-120 μm were fabricated and used in electrochemical cells to facilitate electrochemical impedance spectroscopy (EIS) characterization.

### Materials Characterizations and Electrochemical Evaluations

X-ray diffraction (XRD) patterns were collected on the AAM pellets, using a PANalytical X'pert ProMPD. Scanning electron microscopy (SEM) imaging was conducted using a FEI Quantum 650.

The composite NCA electrode was transferred into a glove box and paired with a Li metal anode. The separator used was Celgard 2325 punched into a circle with an area of 2cm² , and the electrolyte was 1.2 M LiPF₆ in 3:7 ethylene carbonate:ethyl methyl carbonate (Gotion). The cell was assembled into a 2032-type coin cell before electrochemical evaluation with a MACCOR multichannel cycler. It was cycled between 2.5-4.4 V (vs. Li/Li⁺) at 0.1 mA cm⁻² (corresponding to C/20, with the C rate determined based on assuming a capacity of 200 mAh g⁻¹ cathode).

The AAM electrodes were first attached to stainless steel current collectors (cathode on a 2032 bottom piece and anode on a spacer) using a carbon paste. The carbon paste was prepared by blending acetylene carbon black (CB), polyvinylpyrrolidone (PVP, Sigma Aldrich, 360 kDa molecular weight), and ethanol with mass ratio of 1:1:20 CB:PVP:ethanol using a Slurry Mixer (Thinky). After attachment, the assembly was dried at 80 °C for 30 mins and then transferred to a glove box. The separator used between the electrodes was glass fiber (G6 from Fisher) punched into a circle with an area of 2cm². The electrolyte was the same as used in the composite cells. The AAM cells were cycled between 1.0-2.8 V (cell voltage). Initial charge/discharge cycles were at C/50 (0.6 mA cm⁻²), where the C rate was determined based on the actual cathode loading and assuming 200 mAh g⁻¹ cathode capacity. Increasing C rates for higher rate cycling were adjusted by the same assumed capacity metric.

For direct current (DC) electronic conductivity measurements, the relatively thinner AAM cathodes of 0% LCO and 5% LCO pellets were sandwiched between two 2032-type coin cell stainless steel spacers, which are thin discs. The spacers had been coated with the custom CB/PVP paste described above to facilitate good adhesion and contact between the AAM electrode and spacer disc. A constant voltage of 0.1 m V was applied and the current was recorded to determine the DC resistance, which then was converted to the DC electronic conductivity based on the geometry of the pellet and assuming Bruggeman scaling for the hard sphere packing of the electroactive material.

For EIS measurements, the thinner cathodes of 0% LCO and 5% LCO were attached to the current collector following the procedure with conductive composite CB/PVP paste described above. For the thinner AAM cathode cells, Celgard 2325 was used as the separator and Li foil was used as the combined counter/reference electrode. EIS was performed on the fresh prepared cells, and also at different voltages (and thus extents of lithiation) within the voltage window of 3.7-4.3 V (vs. Li/Li⁺). The cells were charged at constant current (0.5 mA cm⁻²) which was followed by a constant voltage hold for 20 hours at each voltage step, where the constant voltage hold was done to facilitate homogeneous spatial lithiation throughout the electrode.

### Material Characterization

Morphology of the as-received NCA powder was evaluated using SEM. The material had a polycrystalline structure with generally spherical secondary morphology with size of ~7 μm and primary particles with sizes of ~500 nm.

Geometric pore/void fraction for AAM cathodes was calculated by determining the volume of the AAM pellets using dimensional measurements from calipers, the mass of each pellet, and an assumed active material density of 4.7 g cm⁻³ for NCA and 5.0 g cm^{31 3} for LCO. After sintering, the pore/void fractions of the pellets for 0% LCO, 2.5% LCO, and 5% LCO were similar and were 0.31-0.32. The 10% LCO pellet, however, had higher pore/void fraction of 0.48. This increased porosity may have been due to additional pore formation during acetate decomposition. Because the 0% LCO did not undergo noticeable shrinkage with the 600 °C thermal processing, the pellet after hydraulic pressing resulted in 68% NCA and 32% pores/voids by volume. In an ideal scenario, the acetates would coat the NCA and/or fill the interstitial regions between NCA particles. Based on the acetate-free interstitial volume, the limit for relative volume in the electrode available for the acetate without impacting the volume loading in the electrode of the NCA would be ~34%. Lithium acetate and cobalt acetate have densities of 1.3 and 1.7 g cm⁻³, and NCA has a reported density of 4.8 g cm⁻³. Just considering the NCA and acetates, the volume fractions for just the solids for NCA for 2.5% LCO, 5% LCO, and 10% LCO was 78%, 63%, and 45% NCA, based on the assumed densities for NCA and the acetates. Based on available interstitial void/pore arguments above, the 2.5% LCO thus had sufficient volume to accommodate the acetate, while the 5% LCO would have slightly below the necessary pore/void volume and the 10% LCO had an acetate volume which exceeded the available pore/void volume by ~160%. This result suggested that after the hydraulic pressing step, the 10% LCO had considerable amount of volume taken by the acetates in addition to what would have been available within interstitial voids/pores. Thus, the geometric pore/void volume would be expected to need to increase to accommodate the excess acetate volume (which subsequently decomposed during thermal treatment), and was consistent with the experimentally observed increase in pore/void volume for 10% LCO and thus reduced volumetric energy density of the AAM electrode using this material relative to the materials with lower acetate/LCO loading. S

The secondary spherical polycrystalline aggregate morphology was less clear after the hydraulic compression processing, and the primary particles appeared interconnected which was speculated to result from the mild sintering. The primary particle morphology and size was not noticeably changed for the 0% LCO, 2.5% LCO, and 5% LCO, although there was a noticeable web/moss texture on the 5% LCO. This web/moss texture was even more prevalent on the 10% LCO sample which had the highest addition of the cobalt oxide coating. Thus, the web/moss morphology material was consistent with the resulting oxide from the decomposition of the lithium and cobalt acetate.

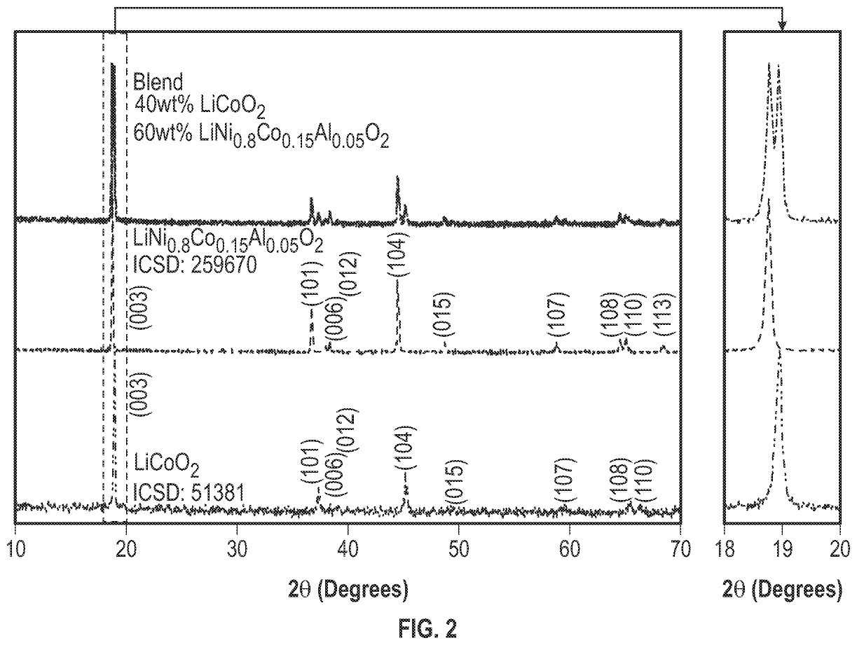

XRD patterns for 0% LCO, 2.5% LCO, 5% LCO, 10% LCO, and a number of relevant reference patterns can be found in the FIG. 2. The XRD patterns for 0% LCO, 2.5% LCO, and 5% LCO were similar, exhibiting the layered phase. This was consistent with the NCA not having any significant structural or compositional change from the hydraulic compression and heat treatment processing, and for all samples most of the material was NCA powder. Also, if LiCoO₂ formed from the lithium and cobalt acetate source materials this would also be a layered phase which would not necessarily be easy to differentiate from the NCA, especially with the low amount of material added. However, for the 10% LCO pellet, on close inspection multiple small peaks were identified. There were weak peaks at 2θ of 18.9°, 37.4°, and 45.2° which were consistent with the target layered LiCoO₂ phase. Peaks at 2θ of 21.4°, 30.5°, and 31.8° were consistent with Li₂CO₃; and a wide peak at 44.3° suggested the existence of some spinel LiₓCo_{y}O₄ phases, where both of these impurities have been previously observed products when synthesizing LCO at low temperatures. The relatively low temperature and short timeframe of the LCO synthesis (600 °C for 1 hour) likely resulted in these impurity phases forming.

### Electrochemical Evaluations

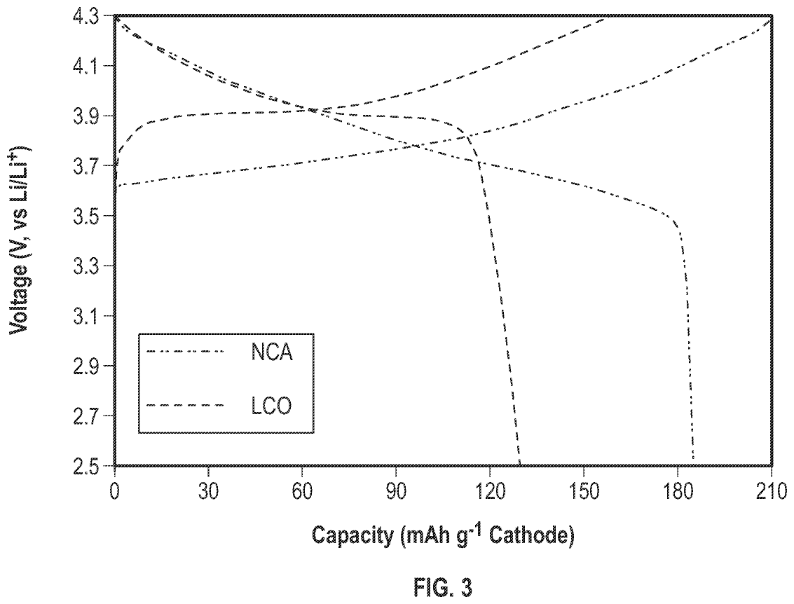

To characterize the commercial NCA material without ionic and electronic transport limitations, NCA in conventional composite electrodes paired with lithium metal anodes were electrochemically cycled at low rate (C/20). The first cycle voltage profile and dQ/dV of first charge can be found in FIG. 3. The first charge and discharge delivered 218 and 193 mAh g⁻¹ cathode, respectively. For this conventional composite electrode cell, capacity initiated from ~3.6 V. The dQ/dV had an initial two peaks at ~3.66 V and ~3.77 V, which were consistent with the phase transition from hexagonal (H1) to monoclinic (M). The following peak from ~3.97 V until ~4.1 V was consistent with the voltage region where there has been reported a phase transition from monoclinic (M) to hexagonal (H2). A final peak occurred at ~4.19 V, suggesting the final phase transition from hexagonal (H2) to hexagonal (H3). The phase transition processes have been reported for similar materials during electrochemical cycling in the literature.

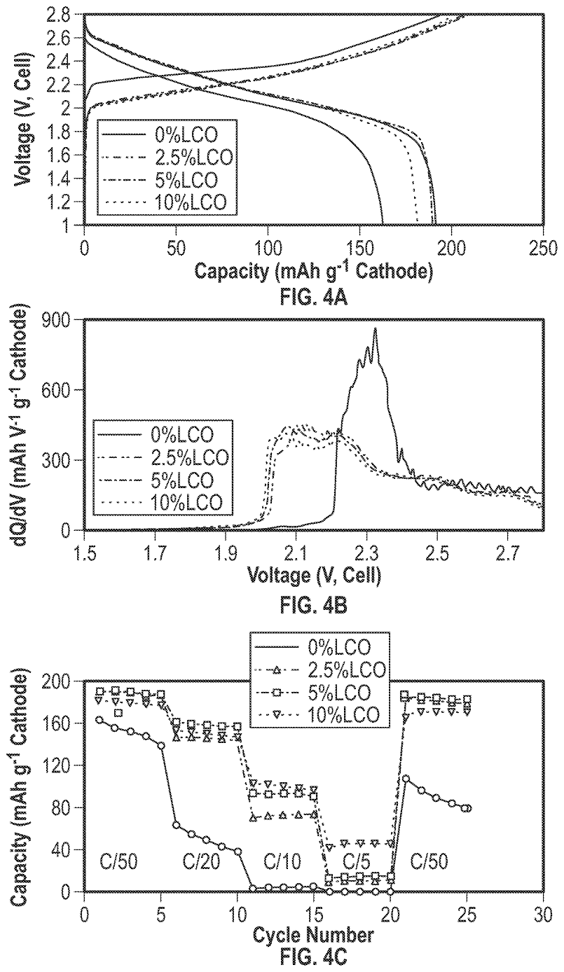

For AAM electrodes, the first cycle voltage profiles at C/50, first charge dQ/dV at C/50, and full rate capability evaluation outcomes can be found in FIG. 4. When looking at the 0% LCO, the first charge and discharge cycles at C/50 achieved 193 mAh g⁻¹ cathode and 163 mAh g⁻¹ cathode, lower capacities than those observed for composite cells containing the same NCA material. In examining the corresponding dQ/dV, the capacity initiated at ~2.2 V (cell). LTO was the anode, which has a flat plateau for charge/discharge at ~1.56 V vs Li/Li⁺. With the NCA composite electrode charge cycle initiating from ~3.6 V when paired with Li metal, relative to LTO the charge would then be expected to initiate at ~2.04 V. This result indicated a relatively large overpotential even at the beginning of the charge cycle that resulted in charge capacity starting at ~2.2 V as opposed to ~2.04 V. It was hypothesized that the source of this overpotential was the limited electronic conductivity (and thus high matrix electronic polarization) of the NCA in the NCA AAM electrode. At the higher rate of C/10, the electrochemical capacity was nearly zero. Such poor rate capability for an AAM electrode material paired with a LTO AAM anode was consistent with our previous reports using an AAM cathode with limited electronic conductivity, and the NCA material would also be expected to have low electronic conductivity.

For the 2.5% LCO, the first charge cycle at C/50 achieved 208 mAh g⁻¹ cathode and discharge was 191 mAh g⁻¹ cathode (FIG. 4a). These values were nearly the same as the composite cell. In addition, in comparison to the 0% LCO, the overpotentials for both charge and discharge were much smaller. Comparing the dQ/dV plots between 2.5% LCO and 0% LCO, the 2.5% LCO initiated charge much earlier at ~2.0 V, around 0.2 V lower than the 0% LCO which had been paired with a nominally identical anode. This lower voltage of initiating charge capacity was attributed to significantly reduced electronic overpotentials in the 2.5% LCO material. At C/20 and C/10, the 2.5%L CO delivered ~75 mAh g⁻¹ cathode and 10 mAh g⁻¹ cathode reversible capacity. With only 2.5wt % addition of the LCO material coating, the rate capability and overpotential improved substantially, which was consistent with the concept of reduced electronic overpotential from the coating. Ionic overpotential, which in many cases is the largest contributor to cell polarization in AAM electrodes.

For the 5% LCO, the voltage profile was similar to that of 2.5% LCO. The corresponding dQ/dV curve from the charge process was also similar, although the charge started from a slightly lower voltage than the 2.5% LCO. At C/20, the 5% LCO AAM electrode cell had similar reversible capacity to the 2.5% LCO. At increasing rates of C/20, C/10, and C/5 the delivered capacity was slightly higher for the 5% LCO at 160 mAh g⁻¹ cathode, 93 mAh g⁻¹ cathode, and 15 mAh g⁻¹ cathode, respectively. The higher capacity at the increased rates may have been due to a further improvement in electronic conductivity for the 5% LCO, though the relative impact was much less so compared to the improvement from 0%L CO to 2.5% LCO.

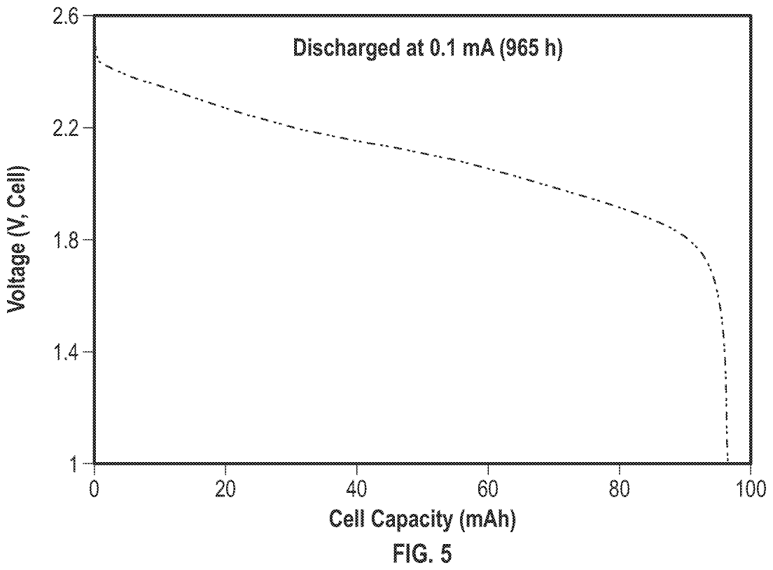

For the 10%L CO, the first charge and discharge cycles at C/50 were 202 mAh g cathode and 182 mAh g⁻¹ cathode, which were less than the 2.5% LCO and 5% LCO. It was suspected that the lower capacity was due to the increase in the relative fraction of LCO material, which even without impurities would have lower gravimetric capacity than the NCA material. Based on the outcomes of the 2.5% LCO and 5% LCO, it was expected that the electronic conductivity limitations of the NCA were no longer a factor in limiting the capacity. The increased porosity for the 10% LCO would reduce the ionic overpotential within the AAM cathode, which generally has been reported as one of the largest sources of overpotential within AAM cells. Thus, with the electronic conductivity improvement from the LCO coating and the increased porosity aiding ionic transport through the electrode microstructure, the 10% LCO had the best rate capability on a cathode gravimetric basis. At higher rates of C/10 and C/5, 10% LCO AAM electrode cell delivered the largest reversible capacity of 100 mAh g⁻¹ cathode and 45 mAh g⁻¹ cathode, respectively. Also, in the dQ/dV, the charge capacity initiated at the lowest voltage among all cells. Representative voltage profiles for all the cells in FIG. 4 at different C rates can be found in FIG. 5.

However, with respect to volumetric energy density, the 10% LCO was inferior to the 5% LCO at rates below C/5. FIG. 3a shows the volumetric capacity (total electrode volume basis) of all AAM electrodes at the rates evaluated. At C/50, the 10% LCO volumetric capacity was below even 0% LCO, while 2.5% LCO and 5% LCO both achieved over 600 mAh cm⁻³ based on the volume of AAM cathode (including pores). Assuming the voltage from LTO anode was 1.6 V, the 2.5% LCO and 5% LCO could realize over 2200 Wh L⁻¹ if paired with Li metal anode. At C/20, the 5% LCO delivered 500 mAh cm⁻³, followed by 2.5% LCO and then 10% LCO. At C/10, the 10% LCO finally surpassed the 2.5% LCO, but was below the 5% LCO. Only at C/5, the 10% LCO had the highest capacity on a volumetric basis.

While the total number of cycles in FIG. 4c was relatively limited, the outcome should be considered in the context that to achieve cycling with reasonable amounts of lithium composition changes in the electroactive materials, these AAM cells have to be cycled at relatively low C-rates due to the high loading and thickness of the electrodes. The target application for these cells at present is considered to be long duration low power cases such as powering wearable health devices. Cycling these AAM cells with large lithiation change was at the rate of C/50, and took ~4 days. The intrinsic properties of these high energy but low power cells make cycle life data more challenging to accumulate. As an example, in a recent publication, a multicomponent AAM cathode with high areal loading and capacity (~50 mAh cm⁻²) was reported with more extended cycling. The capacity retention was~89%, with the total number of cycles being 65 over a ~14 month time period. Optimized cycle life cells for the metal oxide incorporated strategy reported herein have been initiated for a future report.

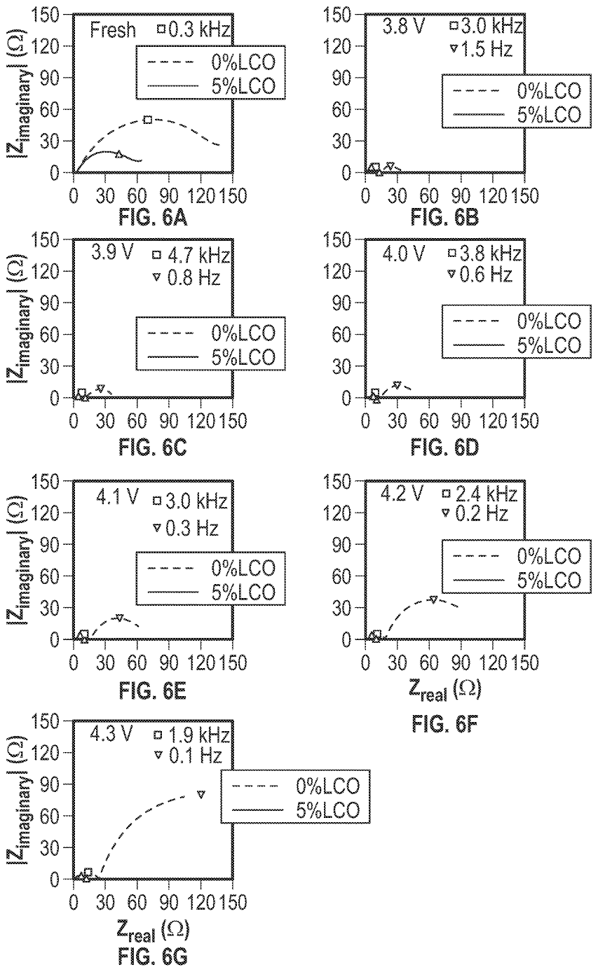

To semi-quantitatively analyze the electronic conductivity improvement of the LCO coating, DC electronic conductivity was measured on the relatively thinner AAM 0% LCO and 5% LCO cathode pellets. These as prepared 0% LCO and 5% LCO matrix electronic conductivity was measured to be 0.0023 S m⁻¹ and 0.092 S m⁻¹, respectively. The 0% LCO was slightly lower than other literature reported values of 0.015-0.02 S m⁻¹, possibly due to slightly different interparticle connectivity from the slightly different measured porosity relative to the prior reports. EIS was performed using relatively thinner AAM 0% LCO and 5% LCO cathodes paired in cells with Li metal electrodes. EIS was conducted on the cells at different potentials, which also corresponded to different states of charge. Corresponding Nyquist plots extracted from the EIS experiments can be found in FIG. 6. EIS high frequency intercepts (R_{cell}) exclude interfacial or diffusion impedance contributions and thus reflected the resistance across the AAM cell. Assuming negligible Li foil electronic resistance, (R_{cell}) was expected to primarily reflect separator region ionic resistance and the combination of the ionic and electronic resistances from the electrode microstructure of the AAM electrode. Current traversed the lowest resistance pathway, with the current distributing between the solid AAM electrode (electronic) and liquid electrolyte (ionic) pathways.

Before charge, the R_{cell} of the 0% LCO was higher than that of 5% LCO, which was consistent with the DC electronic conductivity measurements. For layered transition metal oxides, upon delithiation the electronic conductivity will increase, where for NCA the electronic conductivity was reported to increase from 10^{-3.7} to 10^{-1.9} S cm⁻¹ from Li_{1.0}NCA to Li_{0.4}NCA. Thus, we expected the R_{cell} to decrease as the state of charge increased when the voltage was higher. However, such trend was not observed in either the 0% LCO or the 5%L CO. For 0% LCO, it was speculated that although the increase in electronic conductivity of NCA was over 1 order of magnitude, the electronic conductivity did not significantly exceed the ionic conductivity of the carbonate-based electrolyte (~10⁻² S cm⁻¹). The current path during EIS thus primarily was through the liquid electrolyte at all voltages during charging of the cell. In addition, side reactions from the SEI and cathode electrolyte interface (CEI) could change the ionic conductivity of the electrolyte, which would affect the measured R_{cell}. For 5% LCO, we speculate that although the electronic conductivity of LiCoO₂ has strong dependence on extent of delithiation, the relative fraction in the AAM electrode was low, and the purity and/or crystallinity of the deposited material may not have been comparable to bulk LCO. Some impurity phases, such as Co-containing spinel phases, would have high electronic conductivity even for the as prepared fresh AAM electrode.

In the Nyquist plots (FIG. 6), starting at 3.8 V the 0% LCO exhibited two semi-circles, while the 5% LCO only had one. The diameter of the second semi-circle for 0% LCO increased from ~15 Ω to ~200 Ω, suggesting increased interfacial resistance. NCA material has been reported to have capacity fading due to particle cracks attributed to volume change, leading to new CEI formation. Electronically conductive surface coatings on NCA have been reported to improve the homogeneity of lithiation/delithiation at the particle level, which was interpreted to mitigate strain during electrochemical cycling. It was speculated the 0% LCO had particle cracking, and possibly increased electrode fracture, due to reduced electronic conductivity which exacerbated heterogeneous lithiation/delithiation at both the particle level and as a function of electrode depth. 5% LCO would have increased matrix electronic conductivity from the applied coating, which was expected to more homogeneously distribute electrochemical delithiation/lithiation processes during charge/discharge.

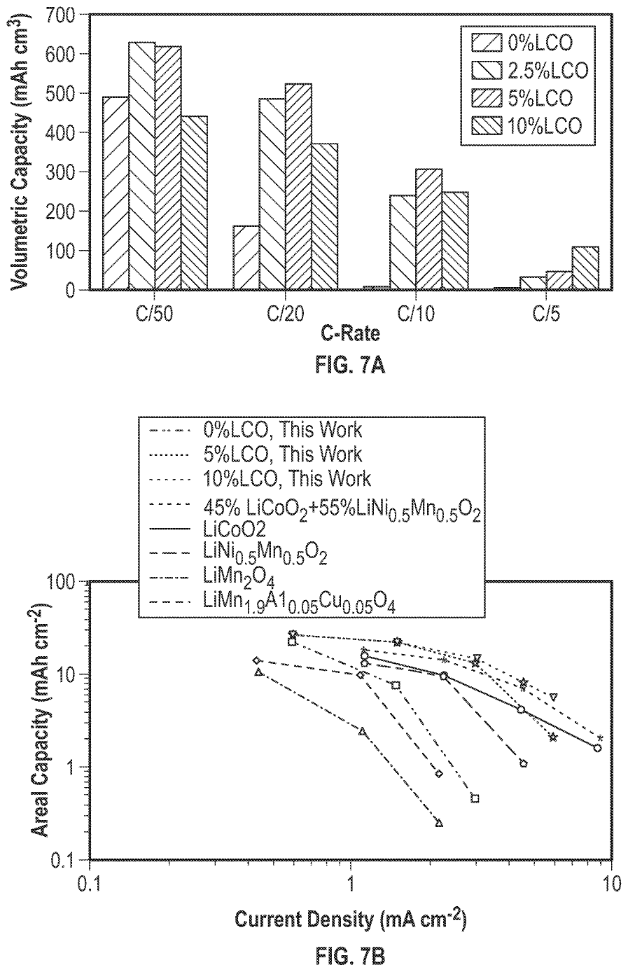

FIG. 7b shows a Ragone plot consisting of a variety of prior reports for AAM cathodes where the cathode loadings were very similar and they were paired with nominally identical LTO as anodes. As can be seen, undoped and doped spinel LMO cathodes were extremely limited in the ability to retain capacity at increasing current densities, which was attributed to the low electronic conductivity of the electroactive material. Electrodes with only layered phase LNMO and NCA had relatively high capacities at low rates due to the relatively high intrinsic gravimetric capacity for these materials; however, retention of capacity at increasing current densities was also low which was also attributed to low electronic conductivity for these materials. Materials that incorporated some amount of LCO, whether through the use of all LCO, a percolated network of LCO (“45% LiCoO₂+55% LiNi_{0.5}Mn_{0.5}O₂), or via the LCO coating in this work, had the highest capacity retention with increasing current density which was attributed to the high electronic matrix conductivity provided by the LCO materials. Thus, as motivated in the introduction the report herein described a route to provide an electronic conduction pathway via coating of a second electroactive material with higher electronic conductivity (LCO) onto the majority electroactive material in the electrode with higher energy density (NCA). The amount of the lower energy density phase is much lower than necessary for forming a percolated mixture of particles, which enabled higher total electrode energy density than a multicomponent blend of particles of two constituent materials. It is expected this strategy will be extendable to other material combinations for enabling high energy density AAM electrodes, so long as the material form compatible interfaces during processing. To provide context for the net energy density at these loadings, consider the case of a 2032-type coin cell geometry. The AAM 5% LCO resulted in a volumetric energy density of ~620 mAh cm⁻³. This could then be paired with AAM LTO that delivered a reported ~360 mAh cm⁻³. Note that these volumetric energy densities include the volume of pores/voids/electrolyte. The total available electrode area and thickness within the 2032 cell are 2 cm² and 0.26 cm. At low rates (e.g., ~1 mA), the capacity would be expected to achieve over 120 mAh. This capacity is about 2× the capacity of commercially available 2032-type coin cell, where for example a ML2032 delivers 60-70 mAh.

NCA was evaluated as an AAM electrode material. The capacity utilization of NCA AAM electrodes was relatively low, especially at higher rates of charge/discharge. This outcome was consistent with high overpotential resulting from the relatively low electronic conductivity of the NCA material. Towards improving the electronic conductivity of AAM electrodes with NCA, the NCA was coated with three different amounts of lithium cobalt oxide via lithium and cobalt acetate source precursors before mild sintering treatment. XRD suggested the conversion to LiCoO₂ was incomplete and impurity spinel cobalt phases and lithium carbonate were also present; however, the electrochemical outcomes of the resulting electrodes suggested increased electronic conductivity in the electrodes from the LCO treatments. The rate capability of the NCA AAM electrodes with only 2.5 wt % LCO was dramatically improved, although at the highest loading of LCO the increased electrode porosity limited overall electrode energy density. At C/10, the 0% LCO had almost no capacity, but coated ones delivered up to 100 mAh g⁻¹ cathode. This study describes a single step process to enable a high energy density but low electronic conductivity material as an AAM electrode with substantial improvements in cell rate capability.

### Conclusion

NCA was evaluated as an AAM electrode material. The capacity utilization of NCA AAM electrodes was relatively low, especially at higher rates of charge/discharge. This outcome was consistent with high overpotential resulting from the relatively low electronic conductivity of the NCA material. Towards improving the electronic conductivity of AAM electrodes with NCA, the NCA was coated with three different amounts of lithium cobalt oxide via lithium and cobalt acetate source precursors before mild sintering treatment. XRD suggested the conversion to LiCoO₂ was incomplete and impurity spinel cobalt phases and lithium carbonate were also present; however, the electrochemical outcomes of the resulting electrodes suggested increased electronic conductivity in the electrodes from the LCO treatments. The rate capability of the NCA AAM electrodes with LCO was dramatically improved, although at the highest loading of LCO the increased electrode porosity limited overall electrode energy density. This study describes a single step process to enable a high energy density but low electronic conductivity material as an AAM electrode with substantial improvements in cell rate capability.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present subject matter. Thus, it should be understood that although the present subject matter has been specifically disclosed by specific aspects and optional features, modification and variation of the concepts herein disclosed may be resorted to by those of ordinary skill in the art, and that such modifications and variations are considered to be within the scope of aspects of the present invention.

### Additional Aspects

The following exemplary aspects are provided, the numbering of which is not to be construed as designating levels of importance:

Aspect 1 provides an electrochemical storage device comprising a layered oxide LiNi_{0.80}Co_{0.15}Al_{0.05}O₂ (NCA) at least partially coated with a coating with stoichiometry LiₓCo_{y}O_{z} (LCO).

Aspect 2 provides the electrochemical storage device of Aspect 1, wherein the electrode is a sintered electrode.

Aspect 3 provides the electrochemical storage device of any one of Aspects 1 or 2, wherein the electrode is a composite electrode.

Aspect 4 provides the electrochemical storage device of Aspect 3, wherein the composite electrode comprises a metallic substrate to which the LiNi_{0.80}Co_{0.15}Al_{0.05}O₂ (NCA) at least partially coated with LiₓCo_{y}O_{z} (LCO) is applied.

Aspect 5 provides the electrochemical storage device of Aspect 4, wherein the metallic substrate comprises a stainless steel, aluminum, alloys thereof, or mixtures thereof.

Aspect 6 provides the electrochemical storage device of any one of Aspects 1-5, wherein a thickness of the electrode is in a range of from about 50 μm to about 2000 μm.

Aspect 7 provides the electrochemical storage device of any one of Aspects 1-6, wherein a thickness of the electrode is in a range of from about 70 μm to about 400 μm.

Aspect 8 provides the electrochemical storage device of any one of Aspects 1-7, wherein the electrode is substantially free of a conductive additive.

Aspect 9 provides the electrochemical storage device of Aspect 8, wherein the conductive additive comprises a polymer binder, a conductive carbon, or a mixture thereof.

Aspect 10 provides the electrochemical storage device of any one of Aspects 1-9, wherein a porosity of the electrode is in a range of from about 30% to about 50%.

Aspect 11 provides the electrochemical storage device of any one of Aspects 1-10, wherein a porosity of the electrode is in a range of from about 35% to about 40%.

Aspect 12 provides the electrochemical storage device of any one of Aspects 1-11, wherein a capacity of the electrode is in a range of from about 7 mAh/cm² to about 100 mAh/cm².

Aspect 13 provides the electrochemical storage device of any one of Aspects 1-12, wherein a capacity of the electrode is in a range of from about 10 mAh/cm² to about 50 mAh/cm².

Aspect 14 provides the electrochemical storage device of any one of Aspects 1-13, wherein the electrode is an anode.

Aspect 15 provides the electrochemical storage device of any one of Aspects 1-14, wherein the electrode is a cathode.

Aspect 16 provides the electrochemical storage device of any one of Aspects 1-15, wherein the electrode comprises one dopant.

Aspect 17 provides the electrochemical storage device of Aspect 16, wherein the electrode comprises at least two dopants.

Aspect 18 provides the electrochemical storage device of any one of Aspects 16 or 17, wherein the at least one dopant has a 1⁺, 2⁺, or 3⁺ oxidation state.

Aspect 19 provides the electrochemical storage device of any one of Aspects 1-18, wherein the at least one dopant comprises copper, aluminum, sulfur, potassium, or a mixture thereof.

Aspect 20 provides the electrochemical storage device of any one of Aspects 1-19, wherein the electrode is a battery anode.

Aspect 21 provides the electrochemical storage device of any one of Aspects 1-20, wherein the electrode is a battery cathode.

Aspect 22 provides the electrochemical storage device of any one of Aspects 1-22, wherein the electrode is free of a binder, an inactive solid additive, or a mixture thereof.

Aspect 23 provides the electrochemical storage device of any one of Aspects 1-22, wherein the LiCoO₂ (LCO) is coated over about 30% to about 100% of the total surface area of the LiNi_{0.80}Co_{0.15}Al_{0.05}O₂ (NCA).

Aspect 24 provides the electrochemical storage device of Aspect 23, wherein the LiCoO₂ (LCO) is coated over about 50% to about 100% of the total surface area of the LiNi_{0.80}Co_{0.15}Al_{0.05}O₂ (NCA).

Aspect 25 provides the electrochemical storage device of Aspect 24, wherein the carbon coating is disposed over about 60% to about 95% of a total surface area of the electrode.

Aspect 26 provides a lithium-ion battery comprising:
a first electrode corresponding to the electrode of any one of Aspects 1-25;
a second electrode spaced apart from the first electrode;
an electrolyte in contact with the first electrode and the second electrode; and
a separator positioned between the first electrode and the second electrode.

Aspect 27 provides the lithium-ion battery of Aspect 26, wherein the electrolyte comprises a salt.

Aspect 28 provides the lithium-ion battery of any one of Aspects 26 or 27, wherein the separator comprises a porous polymer or glass fiber impregnated with electrolyte.

Aspect 29 provides the lithium-ion battery of Aspect 28, wherein the polymer comprises a polyurethane, a polypropylene, a polyethylene, a copolymer thereof, or a mixture thereof.

Aspect 30 provides the electrochemical storage device of any one of Aspects 1-29, wherein the electrochemical storage device comprises a lithium-ion battery.

Aspect 31 provides an article comprising the electrochemical storage device of any one of Aspects 1-30.

Aspect 32 provides the article of Aspect 31, wherein the article comprises a vehicle or an electronic device.

Aspect 33 provides a method of making the electrode of any one of Aspects 1-32, the method comprising:
contacting components of an electroactive material;
blending the components of the electroactive material; and
sintering the blended electroactive material to form the sintered electrode.

Aspect 34 provides the method of Aspect 33, wherein the sintering is performed at a temperature in range of from about 500 °C to about 1100 °C.

Aspect 35 provides the method of any one of Aspects 33 or 34, wherein the sintering is performed at a temperature in range of from about 700 °C to about 900 °C.

Aspect 36 provides the method of any one of Aspects 33-35, wherein sintering is performed at a variable temperature.

Aspect 37 provides the method of any one of Aspects 33-36, wherein sintering is performed over a period of time in a range of from about 0.1 hours to about 20 hours.

Aspect 38 provides the method of any one of Aspects 33-37, wherein sintering is performed over a period of time in a range of from about 16 hours to about 18 hours.

1. An electrochemical storage device comprising an electrode comprising a layered oxide LiNi_{0.80}Co_{0.15}Al_{0.05}O₂ (NCA) at least partially coated with a coating with stoichiometry LiₓCo_{y}O_{z} (LCO).

2. The electrochemical storage device of claim 1, wherein the electrode comprises all electroactive materials, electroactive materials facilitate improved electronic conduction through a microstructure matrix of the electrode.

3. The electrochemical storage device of claim 1, wherein the electrode is a composite electrode or a sintered electrode.

4. The electrochemical storage device of claim 3, wherein the composite electrode comprises a metallic substrate to which the LiNi_{0.80}Co_{0.15}Al_{0.05}O₂ (NCA) at least partially coated with LiₓCo_{y}O_{z} (LCO) is applied, wherein the metallic substrate comprises a stainless steel, aluminum, alloys thereof, or mixtures thereof.

5. (canceled)

6. (canceled)

7. (canceled)

8. The electrochemical storage device of claim 1, wherein the electrode is substantially free of a conductive additive in addition to the electroactive material coating.

9. The electrochemical storage device of claim 8, wherein the conductive additive comprises a polymer binder, a conductive carbon, or a mixture thereof.

10. The electrochemical storage device of claim 1, wherein a porosity of the electrode is in a range of from about 30% to about 50%.

11. (canceled)

12. The electrochemical storage device of claim 1, wherein a capacity of the electrode is in a range of from about 7 mAh/cm² to about 100 mAh/cm².

13. (canceled)

14. The electrochemical storage device of claim 1, wherein the electrode is an anode or a cathode.

15. (canceled)

16. The electrochemical storage device of claim 1, wherein the electrode comprises one dopant.

17. The electrochemical storage device of claim 16, wherein the electrode comprises at least two dopants.

18. The electrochemical storage device of claim 16, wherein the at least two dopants has a 1⁺, 2⁺, or 3⁺ oxidation state.

19. The electrochemical storage device of claim 1, wherein the at least two dopants comprises copper, aluminum, sulfur, potassium, or a mixture thereof.

20. (canceled)

21. (canceled)

22. The electrochemical storage device of claim 1, wherein the electrode is free of a binder, an inactive solid additive, or a mixture thereof.

23. The electrochemical storage device of claim 1, wherein the LiCoO₂ (LCO) is coated over about 30% to about 100% of the total surface area of the LiNi_{0.80}Co_{0.15}Al_{0.05}O₂ (NCA).

24. The electrochemical storage device of claim 23, wherein the LiCoO₂ (LCO) is coated over about 50% to about 100% of the total surface area of the LiNi_{0.80}Co_{0.15}Al_{0.05}O₂ (NCA).

25. (canceled)

26. A lithium-ion battery comprising:
a first electrode corresponding to the electrode of claim 1;
a second electrode spaced apart from the first electrode;
an electrolyte in contact with the first electrode and the second electrode; and
a separator positioned between the first electrode and the second electrode.

27. (canceled)

28. The lithium-ion battery of claim 26, wherein the separator comprises a porous polymer or glass fiber impregnated with electrolyte.

29. (canceled)

30. The electrochemical storage device of claim 1, wherein the electrochemical storage device comprises a lithium-ion battery.

31. (canceled)

32. (canceled)

33. A method of making the electrode of claim 1, the method comprising:
contacting components of an electroactive material;
blending the components of the electroactive material; and
sintering the blended electroactive material to form the sintered electrode.

34. (canceled)

35. (canceled)

36. (canceled)

37. (canceled)

38. (canceled)
